(19) United States
(12) Patent Application Publication
(10) Pub. No.: US 2024/0092040 A1
(43) Pub. Date: Mar. 21, 2024

(54) METHOD FOR PREPARING COMPOSITE PARTS WITH A HIGH DEGREE OF CONSOLIDATION

(71) Applicant: ARKEMA FRANCE, COLOMBES (FR)

(72) Inventors: Arthur BABEAU, Lacq (FR); Axel SALINIER, Lacq (FR); Thibaut SAVART, Lacq (FR); Gilles HOCHSTETTER, Colombes Cedex (FR)

(73) Assignee: ARKEMA FRANCE, COLOMBES (FR)

(21) Appl. No.: 18/273,544

(22) PCT Filed: Feb. 3, 2022
(86) PCT No.: PCT/FR2022/050204

§ 371 Date: Jul. 20, 2023

(30) Foreign Application Priority Data
Feb. 5, 2021 (FR) FR2101119

(51) Int. Cl. B29C 70/38; B29C 70/32; B29C 70/54

(52) U.S. Cl. CPC B29C 70/386; B29C 70/32; B29C 70/54; B29K 2995/004; B29L 2031/52

(57) ABSTRACT

A method for preparing composite parts, including a step of depositing at least one band of fibrous material impregnated with a thermoplastic polymer on a substrate, by means of a main heating system selected from the following two systems: a preheating system (1) and a heating system (2), in combination with at least one secondary heating system selected from: a heating system (3), a post-heating system (4), a heating system (5), and a preheating system (6), or by means of the two main heating systems (1) and (2), the substrate being previously devoid of any deposited band or comprising at least one band n−1 of said fibrous material, the thermoplastic polymer being amorphous, with a Tg such that Tg≥80° C., or semicrystalline, with a Tm≥150° C.

### TECHNICAL FIELD

The present patent application relates to a method for preparing composite parts with a high degree of consolidation and the composite parts as such.

### PRIOR ART

Manufacturing a composite part from thermoplastic ribbon (or tape), deposited so that the final composite part is directly produced in one step and has satisfactory mechanical strength and satisfactory crystallization of the resin, is difficult to achieve.

The manufacturing quality of a thermoplastic composite and its cost/performance ratio depend on a number of criteria.

When composites are manufactured from impregnated thermoplastic bands, there are criteria relating to the material health of the material (impregnation quality, system control of dimensional parameters, etc.) and the nature thereof (type of fibers, type of resin, reinforcement content, etc.).

Several patents or patent applications describe obtaining tape impregnated with a thermoplastic polymer, such as international applications WO 2018/234436, WO 2018/234439 and WO 2018/234434.

European patent application EP3711915 describes a method for preparing parts made from a composite material by depositing preforms made from a composite material on a rotating support and locally applying a thermoplastic tape to the preforms.

Application US2020/230872 describes a shaping apparatus on which a composite material is shaped.

Application US2017/151731 describes an apparatus moving on a thermo weldable composite part.

There are also criteria relating to the depositing of these bands. When semicrystalline resins with a high glass transition temperature (Tg) are used, a high molar mass is necessary in order to obtain satisfactory mechanical properties, which leads to problems in welding the tapes to each other as this type of resin with a high molar mass and a high Tg also has high viscosity. In addition, the crystallization speeds of this type of high Tg semicrystalline resin are generally slow and prevent a method in which in situ consolidation of the composite formed is carried out from being sufficiently productive to be economically viable.

In the aeronautical field, ATL (Automated Tape Laying) technologies can be used to manufacture high-performance parts. This system family of methods is broken down into a number of technologies, such as AFP (Automated Fiber Placement), tape winding (for manufacturing parts with rotational geometry), etc. Robots unwind and place preimpregnated bands in very specific locations by means of a robotic system. This system is generally broken down into a multiaxial robotic arm at the end of which is attached a deposition head within which the preimpregnated bands run. The head serves to guide these bands, but also to cut them when the trajectory of the robot changes during the manufacturing of the part. It also generally comprises a consolidation roller making it possible to apply pressure to the bands during deposition. Finally, it is provided with one or more heating means making it possible to heat the impregnated band in order to melt the polymer that it contains and thus making it possible to bond it to the band or the substrate on which it is deposited.

A number of heating means can be used on this deposition head: laser, light-emitting diode or LED, ultraviolet (UV), hot air source, infrared (IR), etc. They heat the layer being deposited and also sometimes slightly heat the substrate on which the bands are deposited in order to facilitate adhesion and improve the quality of the composite deposited.

In flat deposition, for manufacturing 2.5D composite preforms, such as in an AFP method for example, it is possible to use means for continuously heating the substrate on which the bands are deposited. However, this is only limited and is very difficult to extrapolate to the production of large parts. In tape winding, these systems of heating mandrels are not used on an industrial scale, and are not used at all for manufacturing hydrogen storage tanks.

The consolidation quality of the preforms resulting from these deposition methods therefore depends greatly on the thermal treatment applied to these bands during deposition. It also depends on how the material deposited responds to this thermal treatment. A crystallized band and/or a band the thermoplastic matrix of which crystallizes very rapidly is difficult to bond perfectly to the cold lower layer already deposited. In addition, the mobility of the molecular chains, which is necessary to achieve satisfactory welding of the tapes, is not sufficient below the Tg and the difficulty of welding on the cold lower layer is therefore amplified if the polymer matrix is a matrix with a high Tg and/or the temperature of the lower layer is poorly controlled. Cold lower layer is given to mean a layer that is solely superficially heated on the surface by the robot's deposition head, at the time of welding, and which cools very rapidly after the robot's deposition head has passed over it. Poor consolidation in these deposition steps is generally detrimental to the final properties of the composite, in particular in terms of mechanical performance.

The final step in the system for producing the composite is the consolidation thereof. This can take place after the band deposition step (autoclave, heating press, oven consolidation, vacuum, etc.). It can also take place during band deposition; this is in-line or in situ consolidation.

If complex (pre)forms that are therefore difficult to consolidate after the event are being manufactured (tanks, hollow tubes, parts with multiple curves, etc.), it is essential to control the consolidation of the part during deposition. This consolidation must not only be of good quality, it must also be uniform over the entire part. This latter aspect very largely depends on the management of a uniform initial band quality, but also on the thermal management of the method during deposition.

For example, if a hydrogen storage tank is being manufactured, the bands are generally heated in the same way whether they are placed on the horizontal portion of the cylinder or on the bases, despite the fact that the speed at which these bands are deposited changes in this deposition zones. The thermal management of the band arriving in contact with the substrate is not therefore controlled, which results in the formation of consolidation disparities on the final part.

It is therefore necessary to remedy the drawbacks listed above.

The present invention therefore relates to a method for preparing composite parts with a high degree of consolidation, comprising n bands of fibrous material impregnated with a thermoplastic polymer deposited on a substrate, characterized in that it comprises a step of depositing at least one band of fibrous material impregnated with a thermoplastic polymer on a substrate,
by means of a main heating system selected from the following two systems:
a system (1) for preheating said impregnated band of fibrous material before said band is deposited on said substrate, and a system for heating said impregnated band of fibrous material on its inner face (2) at the point of contact of said band with said substrate,
in combination with at least one secondary heating system selected from the following four:
a system for heating said impregnated band of fibrous material on its outer face (3) at the point of contact of said band with said substrate, a system (4) for post-heating said impregnated band n of fibrous material after said band n has been deposited on said substrate, a system (5) for heating said substrate, and a system (6) for preheating the impregnated band n−1 of fibrous material previously deposited before said band n of fibrous material is deposited,
or by means of the two main heating systems (1) and (2) optionally combined with at least one of the four secondary systems (3), (4), (5), and (6),
said substrate being previously devoid of any deposited band or comprising at least one previously deposited band n−1 of said fibrous material impregnated with a thermoplastic polymer,
said at least two heating systems being present to increase the adhesion of said band to the substrate or to the previously deposited band n−1,
said thermoplastic polymer being an amorphous polymer, with a glass transition temperature such that Tg≥80° C., in particular Tg≥100° C., particularly ≥120° C., in particular ≥140° C., or a semicrystalline polymer with a melting temperature Tm≥150° C.,
the temperature of said band n to be deposited being constant throughout the deposition thereof on said substrate,
excluding the following heating pairs when only two heating systems are present:
a heating system (2) and a heating system (5) if the heating system (2) is a laser system,
and excluding the following three systems when only three heating systems are present:
a preheating system (1), a post-heating system (4) and a preheating system (6) in the presence of a cylindrical substrate simultaneously rotating about and translating along the axis of the cylinder, the three systems being infrared heating systems and the two systems (4) and (6) being combined.

In one embodiment, said method defined above also excludes the following three systems when only three heating systems are present:
a system (1) for preheating said impregnated band of fibrous material before said band is deposited on said substrate, a system for heating said impregnated band of fibrous material on its inner face (2) at the point of contact of said band with said substrate, and a system for heating said impregnated band of fibrous material on its outer face (3) at the point of contact of said band with said substrate.

In one embodiment, said method defined above is characterized by a main heating system selected from the following two systems:
a system (1) for preheating said impregnated band of fibrous material before said band is deposited on said substrate, and a system for heating said impregnated band of fibrous material on its inner face (2) at the point of contact of said band with said substrate, combined with at least one secondary heating system selected from the following three:
a system (4) for post-heating said impregnated band n of fibrous material after said band n has been deposited on said substrate, a system (5) for heating said substrate, and a system (6) for preheating the impregnated band n−1 of fibrous material previously deposited before said band n of fibrous material is deposited,
or two main heating systems (1) and (2) optionally combined with at least one of the three secondary systems (4), (5), and (6),
said substrate being previously devoid of any deposited band or comprising at least one previously deposited band n−1 of said fibrous material impregnated with a thermoplastic polymer.

The expression “a system for heating said impregnated band of fibrous material on its inner face (2) at the point of contact of said band with said substrate” therefore means that said impregnated band of fibrous material to be deposited is heated on its inner face at the point of contact of said band with said substrate.

The expression “a system for heating said impregnated band of fibrous material on its outer face (3) at the point of contact of said band with said substrate” therefore means that said impregnated band of fibrous material to be deposited is heated on its outer face at the point of contact of said band with said substrate.

Throughout the description, the terms ribbon or band or bands of fibrous material impregnated with a thermoplastic polymer or tape can be used, and denote the same thing.

The bands can be deposited according to one of the prior art methods described above.

Deposition can in particular be carried out with a deposition head and/or a guide.

The term “substrate” denotes any base on which the bands n are successively deposited. When a first band is deposited on said substrate, the substrate is bare, that is, devoid of any material other than the material forming said substrate. After a first band has been deposited, it can fully cover the whole surface of the substrate.

A band deposited on said bare substrate or a preceding band already deposited has an inner face and an outer face, the inner face being in contact with said substrate or the outer face of the preceding band already deposited.

In this case, the next band n deposited by the method of the invention covers the band n−1 previously deposited, and so on.

It can equally only partially cover the surface of the substrate. In this case, the next band n deposited by the method of the invention does not cover the preceding band n−1 but is deposited on the substrate and overlaps or does not overlap or adjoins the band n−1 previously deposited on the substrate.

If the next band n deposited by the method of the invention overlaps or adjoins the band n−1 previously deposited on the substrate, this continues until the whole of the substrate is covered with a single band thickness.

If the next band n deposited by the method of the invention does not overlap and does not adjoin the band n−1 previously deposited on the substrate, this continues to the other end of the substrate and consequently a plurality of bands over a single band thickness partially cover the substrate. The next bands are deposited on the first series of bands (the plurality of bands over a single band thickness) either in the same way or “crossed” on top of the first series.

The deposition of bands forming a fabric of intersecting or interlaced bands in advance is excluded from the invention.

The substrate can have any shape, but as a general rule it is flat, 2.5D, or cylindrical.

Examples of a flat shape are a flat square or rectangle.

A 2.5D shape means a deviation from the flat shape, locally or generally, such as a shell comprising a curve for example, the dimensions in the 3rd dimension of which are far smaller than the dimensions in the other two dimensions.

When it is a flat shape, the substrate can be fixed or rotating, particularly fixed.

If it is rotating, the axis of rotation is not in the plane of the substrate and the head depositing the band that makes it possible to place the band and the substrate in contact is moved translatably in the plane of the substrate.

When the substrate is a 2.5D shape, the head depositing the band that makes it possible to place the band and the substrate in contact is moved in all three dimensions.

The substrate can be provided with a secondary heating system (5).

A non-limiting example of a heating system (5) on a fixed flat substrate is shown in FIG. 1.

Cylindrical shape is given to mean a cylinder that is a ruled surface with parallel generatrixes, that is, a surface in the space consisting of parallel straight lines.

When it is cylindrical, the substrate can simultaneously rotate about and translate along the axis of the cylinder while the head depositing the band that makes it possible to place the band and the substrate in contact is fixed.

A non-limiting example of infrared heating systems (6) and (4) combined in the presence of a cylindrical substrate rotating about and translating along the axis of the cylinder (5), heating or non-heating, is shown in FIG. 2.

Alternatively, when the substrate is cylindrical, the substrate can be rotating about the axis of the cylinder, while the head depositing the band that makes it possible to place the band and the substrate in contact is moved translatably parallel to the axis of the tube.

The substrate can be made from any material provided that it can resist the heat of the various heating means and the heat of the band itself, as well as the pressure exerted during the deposition of the bands.

The substrate can be a thermoplastic or thermoset material, or a metal material, or a ceramic material, or a combination of these materials, provided that it meets said aforementioned conditions.

The inventors have therefore surprisingly found that a method comprising a step of depositing at least one band of fibrous material impregnated with a thermoplastic polymer on a substrate, by means of at least two heating systems selected from five particular systems makes it possible to:

Obtain parts with a high degree of consolidation through a method for depositing bands impregnated with a thermoplastic polymer or a mixture of thermoplastic polymers at least one of which has a high glass transition temperature by fully controlling the deposition temperature of the bands by varying the heating power applied to the band as a function of the deposition speed, thus making it possible to have a band that has an equivalent temperature at any point of the composite part at the time of its deposition, regardless of the shape of this part, and by fully controlling the temperature of the bands already deposited or to be deposited by adding other means of heating the part during deposition.

Obtain parts with a high degree of consolidation through a method for depositing bands impregnated with a thermoplastic polymer or a mixture of thermoplastic polymers at least one of which has a high glass transition temperature and having low porosity with or without post-consolidation of this part.

Obtain parts with a high degree of consolidation through a method for depositing bands impregnated with a thermoplastic polymer or a mixture of thermoplastic polymers at least one of which has a high glass transition temperature by fully controlling the deposition temperature of the bands in the sense that only the amount of heat necessary for the band is supplied, with limited thermal degradation of the thermoplastic polymer.

Obtain parts with a high degree of consolidation through a method for depositing bands impregnated with a thermoplastic polymer or a mixture of thermoplastic polymers at least one of which has a high glass transition temperature by fully controlling the deposition pressure applied to the bands in order to avoid in particular the deconsolidation of these bands, for example by means of a heating pressure roller the pressure of which, applied to the tape, is controlled.

Obtain parts with a high degree of consolidation through a method for depositing bands impregnated with a thermoplastic polymer or a mixture of thermoplastic polymers at least one of which has a high glass transition temperature and having very slow crystallization kinetics in order to optimize the adhesion between two successive plies deposited and comprising a heating device also making it possible to optimize the crystallization of the resin after deposition.

Obtain parts with a high degree of consolidation through a method for depositing bands impregnated with a thermoplastic polymer or a mixture of thermoplastic polymers at least one of which has a high glass transition temperature and having low initial viscosity in order to optimize the adhesion between two successive deposited plies.

Obtain parts with a high degree of consolidation through a method for depositing thermoplastic impregnated bands with a high glass transition temperature and having significant weight increase potential in order to optimize the final mechanical properties of the part; the maximum consolidation and weight increase can possibly be obtained during the deposition of the bands and without post-consolidation.

Obtain parts with a high degree of consolidation through a method for depositing bands impregnated with a thermoplastic polymer or a mixture of thermoplastic polymers at least one of which has a high glass transition temperature that are equivalently consolidated at all points of the composite part.

Obtain parts with a high degree of consolidation through a method for depositing bands impregnated with a thermoplastic polymer or a mixture of thermoplastic polymers at least one of which has a high glass transition temperature that are used in fields requiring high-quality performance, in particular mechanical, such as automotive and aeronautical structural parts, gas storage tanks (hydrogen, nitrogen, etc.), sport and leisure, transport in general, etc.

The Bands or Ribbon

In the present description, “fibrous material” is given to mean an assembly of individual reinforcing fibers. After impregnation with the thermoplastic polymer (the resin), it takes the form of an individual band or ribbon.

Individual band or ribbon is given to mean a strip that is a thin semi-finished product, the width and thickness of which are uncalibrated, made up of a single fiber roving, or a thin tape made up of one or more fiber rovings, the thickness and width of which are calibrated, or a tape the thickness and width of which are calibrated and the thickness of which is greater than 100 μm. These tapes can also be obtained after an optional step of longitudinally cutting, otherwise known as slitting, an initially wider tape.

There is on the substrate either a single layer of one or more bands, in particular with the same thickness, or a plurality of layers of one or more bands, in particular with the same thickness, each band of each band layer adhering at least partially to a band of the lower band layer.

Advantageously, all of the bands deposited have the same thickness, to within manufacturing tolerance.

Advantageously, the bands deposited have a thickness less than or equal to 300 μm, more advantageously less than 250 μm.

Advantageously, the ribbon or band has a thickness less than or equal to 150 μm, preferably less than or equal to 100 μm.

The Heating Systems

FIG. 1 non-limitingly shows an example of different heating systems as mentioned above on a substrate.

Said at least one heating system can be selected from a heat transfer fluid, direct current, a heating cartridge, induction heating, a heating pressure roller, a light-emitting diode (LED), infrared (IR), a source of UV, hot air, or a laser.

The expression “said at least one heating system can be selected from” therefore means that one or more of the heating systems of the method defined above can be selected from the energy sources defined above, that is, heating by conduction (heat transfer fluid, heating cartridge, heating pressure roller), by induction, by radiation (light-emitting diode or IR or UV or laser lamp), or by convection (hot air).

Advantageously, said heating systems present are all infrared systems.

Advantageously, said heating systems present are all infrared systems with the exception of the system (5) for heating said substrate, which can also be selected from a heat transfer fluid, direct current, a heating cartridge, and induction heating. The step of depositing at least one band of fibrous material impregnated with a thermoplastic polymer on a substrate takes place by means of a main heating system selected from the following two systems:
a system (1) for preheating said impregnated band of fibrous material before said band is deposited on said substrate, and a system for heating said impregnated band of fibrous material on its inner face (2) at the point of contact of said band with said substrate,
in combination with at least one secondary heating system selected from the following four:
a system for heating said impregnated band of fibrous material on its outer face (3) at the point of contact of said band with said substrate, a system (4) for post-heating said impregnated band n of fibrous material after said band n has been deposited on said substrate, a system (5) for heating said substrate, and a system (6) for preheating the impregnated band n−1 of fibrous material previously deposited before said band n of fibrous material is deposited,
or by means of the two main heating systems (1) and (2) optionally combined with at least one of the four secondary systems (3), (4), (5), and (6),
said systems having the following details:
   said system (1) for preheating said impregnated band of fibrous material before said band is deposited on said substrate, or the heating system (2) that makes it possible to heat both the deposited band and the band to be deposited just before it is deposited on the preceding band, are each used in combination with at least one of the heating systems (3), (4), (5), or (6).

The heating system (1) makes it possible to preheat the band before it is deposited and to bring the thermoplastic polymer of this band being deposited to a temperature close to its melting point if it is semicrystalline, but in any event greater than the Tm, in particular to a temperature beyond the end of melting of the thermoplastic polymer, otherwise known as the endset melting temperature and denoted Tm_{endset}, particularly to Tm_{endset}+10° C., or close to its Tg if it is amorphous, but in any event greater than the Tg, particularly to a temperature of Tg+100° C., in particular greater than 150° C.

The temperature Tm_{endset} (or Tf_{fm} as defined in standard 11357-3:2013) corresponds to the temperature at which the endothermic melting peak rejoins the baseline (and therefore at the end of melting) as opposed to the temperature Tmₒₙₛₑₜ (or Tfᵢₘ as defined in standard 11357-3:2013), which corresponds to the temperature at which the endothermic melting peak “detaches” from the baseline.

The heating system (2) makes it possible to preheat the band before it is deposited and to bring the thermoplastic polymer of this band being deposited and of the band on which it is deposited to a temperature close to its melting point if it is semicrystalline, but in any event greater than the Tm, in particular to a temperature beyond the end of melting of the thermoplastic polymer, otherwise known as the endset melting temperature and denoted Tm_{endset}, particularly to Tm_{endset}+10° C., or close to its Tg if it is amorphous, but in any event greater than the Tg, particularly to a temperature of Tg+100° C., in particular greater than 150° C.

If the heating systems (1) and (2) are present together, then (1) makes it possible to preheat the band before it is deposited and to bring the thermoplastic polymer of this band being deposited to a temperature close to its melting point if it is semicrystalline, but in any event greater than the Tm, in particular to a temperature beyond the end of melting of the thermoplastic polymer, otherwise known as the endset melting temperature and denoted Tm_{endset}, particularly to Tm_{endset}+10° C., or close to its Tg if it is amorphous, but in any event greater than the Tg, particularly to a temperature of Tg+100° C., in particular greater than 150° C., and (2) aims to keep the thermoplastic polymer of said band at a temperature close to its crystallization temperature, Tc, as determined by differential scanning calorimetry (DSC) in accordance with standard 11357-3:2013 if it is semicrystalline, but in any event between Tc−60° C. and Tc+20° C., preferably between Tc−20° C. and Tc+10° C., particularly at a temperature equal to Tc, or close to its Tg if it is amorphous but in any event less than the Tg, particularly at a temperature equal to Tg−10° C., preferably Tg−20° C., and vice versa.

The expression “Tc−60° C.” or “Tc−20° C.” denotes a temperature having a value of Tc from which 60° C. or 20° C. has been subtracted, and the expression “Tc+20° C.” or “Tc+10° C.” denotes a temperature having a value to which 20° C. or 10° C. has been added.

The two systems (1) and (2) can be combined, if applicable, with at least one secondary heating system selected from the systems (3), (4), (5), and (6).

When it is semicrystalline, said thermoplastic polymer can then have a degree of crystallinity close to 0.

The degree of crystallinity of a semicrystalline polymer can be determined by DSC by determining the enthalpy of melting and comparing the enthalpy of melting obtained with that of the same semicrystalline polymer having a crystallinity of 100%.

It can also be determined by X-ray diffraction.

The preheating system (1) can be an IR, light-emitting diode (LED), hot air, ultraviolet (UV), nitrogen torch (N2), or laser heating system.

Advantageously, the preheating system (1) is an IR heating system.

The preheating system (2) can be an IR, light-emitting diode (LED), hot air, ultraviolet (UV), nitrogen torch (N2), or laser heating system.

Advantageously, the heating system (2) is an IR heating system.

The heating system (3) makes it possible to heat the band being deposited to a temperature close to the crystallization temperature of the resin, just after it has been deposited on the preceding band, and to help to perfect the contact between the deposited band and the preceding band, which promotes a high quality weld between the two layers.

The heating system (4) is a system for post-heating said impregnated band n of fibrous material after said band n has been deposited on said substrate, which helps with the crystallization of the resin by keeping the band n, after it has been deposited on and welded to the band n−1, at a temperature close to the crystallization temperature of the resin.

The system (5) for heating said substrate and the system (6) for preheating the impregnated band n−1 of fibrous material previously deposited before said band n of fibrous material is deposited both promote the quality of the welding of the band n to the band n−1 by keeping at temperature or heating the surface on which the band n will be deposited to a temperature close to the crystallization temperature of the resin. These two heating means (5) and (6) can also help to promote the crystallization of the resin.

The heating systems (3), (4), (5), and (6) aim to keep the thermoplastic polymer of said band at a temperature close to its crystallization temperature, Tc, as determined by differential scanning calorimetry (DSC) in accordance with standard 11357-3:2013 if it is semicrystalline, but in any event between Tc−60° C. and Tc+20° C., preferably between Tc−20° C. and Tc+10° C., particularly at a temperature equal to Tc, or close to its Tg if it is amorphous, but in any event less than the Tg, particularly at a temperature equal to Tg−10° C., preferably Tg−20° C.

The heating systems (3), (4), (5), and (6) are necessarily used in combination with at least one of the heating systems (1) and (2), but are optional when both heating systems (1) and (2) are present.

The preheating system (3) can be an IR, light-emitting diode (LED), hot air, ultraviolet (UV), nitrogen torch (N2), or laser heating system, or a heating pressure roller system.

The temperature of the heating pressure roller can be regulated (heating cartridges, integrated cooling system, etc.) to avoid cooling or overheating the band on contact therewith. The pressure applied can also be controlled by managing the mechanical tension applied when depositing the band (brake system on the creel associated with the robot or similar).

Advantageously, the heating system (3) is an IR heating system.

Advantageously, the degree of crystallinity of the thermoplastic polymer in the band after it has been deposited is greater than 5%, particularly greater than 10%, preferably greater than 15%.

The system (5) for heating the substrate can be produced by a heat transfer fluid or direct current circulating in the substrate, or a heating cartridge.

The temperature of the heat transfer fluid can be regulated by one of the techniques known to a person skilled in the art.

The power of the direct current makes it possible to regulate the temperature.

The temperature of the heating cartridge can be regulated by a conventional PID system, in particular by a temperature probe.

In one embodiment, the substrate is cylindrical and corresponds to a hollow tube, and the heating can take place from the inside of the tube using an IR system.

In this latter embodiment, the temperature of the heating system (5) is between Tc−60° C. and Tc+20° C., preferably between Tc−20° C. and Tc+10° C., particularly a temperature equal to Tc, Tc being the crystallization temperature as determined by differential scanning calorimetry (DSC) in accordance with standard 11357-3:2013, when one or more of the heating systems (1), (3), and (2) are present.

Advantageously, the degree of crystallinity of the thermoplastic polymer in the band after it has been deposited is greater than 5%, particularly greater than 10%, preferably greater than 15%;
and
said preheating system (6) makes it possible to heat the band that has just been deposited (layer n−1) so as to keep the thermoplastic polymer of said band at a temperature close to its melting point if it is semicrystalline, but in any event lower than the Tm, particularly at a temperature of Tm−10° C., or close to its Tg if it is amorphous, but in any event lower than the Tg, particularly at a temperature of Tg−10° C.

If a heating system (3) is present at the same time as the preheating system (6), then the heating system (3) heats so as to keep the thermoplastic polymer of the band being deposited at a temperature close to its melting point if it is semicrystalline, but in any event greater than the Tm_{endset}, particularly at a temperature of Tm_{endset}+10° C., or close to its Tg if it is amorphous, particularly at a temperature of Tg+100° C. during deposition.

If a heating system (2) is present at the same time as the preheating system (6), then the heating system (2) heats so as to keep the thermoplastic polymer of the band being deposited at a temperature close to its melting point if it is semicrystalline, but in any event greater than the Tm_{endset}, particularly at a temperature of Tm_{endset}+10° C., or close to its Tg if it is amorphous, particularly at a temperature of Tg+100° C. during deposition.

The preheating system (6) can be an IR, light-emitting diode (LED), hot air, ultraviolet (UV), nitrogen torch (N2), or laser heating system.

Advantageously, the preheating system (6) is an IR heating system.

In one embodiment, the temperature of the preheating system (6) is between Tc−60° C. and Tc+20° C., preferably between Tc−20° C. and Tc+10° C., particularly a temperature equal to Tc, Tc being the crystallization temperature as determined by differential scanning calorimetry (DSC) in accordance with standard 11357-3:2013, when one or more of the heating systems (1), (3), and (2) are present.

Advantageously, the degree of crystallinity of the thermoplastic polymer in the band after it has been deposited is greater than 5%, particularly greater than 10%, preferably greater than 15%;

In one embodiment, in addition to the exclusions defined above, when only two heating systems are present, then the following heating system pairs:
a post-heating system (4) with a heating system (5), a post-heating system (4) with a preheating system (6), and a heating system (5) with a preheating system (6)
are excluded.

In a first embodiment, at least one of the heating systems is selected from a preheating system (1), a heating system (3), and a heating system (2).

Advantageously, in this first embodiment, at least one other heating system is selected from a post-heating system (4), a heating system (5), and a preheating system (6), and in particular the temperature of said at least one other heating system (5) and (6) is between Tc−60° C. and Tc+20° C. and the temperature of said at least one other heating system (6) is less than Tm and particularly equal to Tm−10° C.

The expression “one other heating system” means that this other heating system is in addition to the heating already present.

Advantageously, in this first embodiment with at least one other heating system in addition, the degree of crystallinity of the thermoplastic polymer in the band after it has been deposited is greater than 5%, particularly greater than 10%, preferably greater than 15%.

Advantageously, the temperature of the band n at the time of deposition at the point of contact of the band n with the band n−1 is constant.

In a second embodiment, two heating systems are present, one being a system (1) for preheating said impregnated band of fibrous material before said band is deposited on said substrate, and the other being a post-heating system (4) or a preheating system (6), an infrared (IR) heating system being excluded from at least one of the two heating systems (1) and (4) or (1) and (6) when they are both present, and in particular the temperature of said at least one other heating system (4) is between Tc−60° C. and Tc+20° C., preferably between Tc−20° C. and Tc+10° C., particularly a temperature equal to Tc, and the temperature of said at least one other heating system (6) is in any event less than the Tm, particularly a temperature equal to Tm−10° C.

Advantageously, in this second embodiment, a heating system (3) is present in addition, said heating system (3) being a heating pressure roller.

In a third embodiment, two heating systems are present, one being a heating system (2) and the other a heating system (5), a laser heating system being excluded from said heating system (2), and in particular the temperature of said at least one other heating system (5) is between Tc−60° C. and Tc+20° C., preferably between Tc−20° C. and Tc+10° C., particularly a temperature equal to Tc.

Advantageously, in this third embodiment, said heating system (3) is a heating pressure roller.

In a fourth embodiment, two heating systems are present, one being a heating system (2) and the other a post-heating system (4) or a preheating system (6), said heating system (2) being a laser heating system and said post-heating system (4) or preheating system (6) being an infrared heating system, and in particular the temperature of said at least one other heating system (4) is between Tc−60° C. and Tc+20° C., preferably between Tc−20° C. and Tc+10° C., particularly a temperature equal to Tc. Advantageously, in this fourth embodiment, a heating system (5) is present in addition.

### PREFERRED EMBODIMENTS

In a first variant of the invention, two heating systems are present, namely a heating system (2), particularly a laser heating system, and a post-heating system (4), particularly an IR heating system, and in particular the temperature of said heating system (4) is between Tc−60° C. and Tc+20° C., preferably between Tc−20° C. and Tc+10° C., particularly a temperature equal to Tc.

In a second variant of the invention, two heating systems are present, namely a heating system (2), particularly a laser heating system, and a preheating system (6), particularly an IR heating system, and in particular the temperature of said preheating system (6) is in any event less than the Tm, particularly a temperature equal to Tm−10° C.

In a third variant of the invention, two heating systems are present, namely a heating system (3), particularly a heating pressure roller system, and a post-heating system (4), particularly an IR heating system, and in particular the temperature of said heating system (4) is between Tc−60° C. and Tc+20° C., preferably between Tc−20° C. and Tc+10° C., particularly a temperature equal to Tc.

In a fourth variant of the invention, two heating systems are present, namely a heating system (3), particularly a heating pressure roller system, and a preheating system (6), particularly an IR heating system, and in particular the temperature of said preheating system (6) is in any event less than the Tm, particularly a temperature equal to Tm−10° C.

In a fifth variant of the invention, two heating systems are present, namely a heating system (3), particularly a heating pressure roller system, and a system (5) for heating the substrate, and in particular the temperature of said heating system (5) is between Tc−60° C. and Tc+20° C., preferably between Tc−20° C. and Tc+10° C., particularly a temperature equal to Tc.

In a sixth variant of the invention, three heating systems are present, namely a heating system (2), particularly a laser heating system, and a post-heating system (4), particularly an IR heating system, and a system (5) for heating the substrate, and in particular the temperature of said heating system (4) and of said heating system (5) is between Tc−60° C. and Tc+20° C., preferably between Tc−20° C. and Tc+10° C., particularly a temperature equal to Tc.

In a seventh variant of the invention, three heating systems are present, namely a heating system (2), particularly a laser heating system, a preheating system (6), particularly an IR heating system, and a system (5) for heating the substrate, and in particular the temperature of said heating system (5) is between Tc−60° C. and Tc+20° C., preferably between Tc−20° C. and Tc+10° C., particularly a temperature equal to Tc, and the temperature of the preheating system (6) is in any event less than the Tm, particularly a temperature equal to Tm−10° C.

In an eighth variant of the invention, three heating systems are present, namely a preheating system (1), particularly an IR heating system, a post-heating system (4), particularly an IR heating system, and a heating system (3), particularly a heating pressure roller system, and in particular the temperature of said heating system (4) is between Tc−60° C. and Tc+20° C., preferably between Tc−20° C. and Tc+10° C., particularly a temperature equal to Tc.

In a ninth variant of the invention, three heating systems are present, namely a heating system (1), particularly an IR heating system, a preheating system (6), particularly an IR heating system, and a heating system (3), particularly a heating pressure roller system, and in particular the temperature of said preheating system (6) is in any event less than the Tm, particularly a temperature equal to Tm−10° C.

In a tenth variant of the invention, four heating systems are present, namely a heating system (2), particularly a laser heating system, a post-heating system (4), particularly an IR heating system, a preheating system (6), particularly an IR heating system, and a system (5) for heating the substrate, and in particular the temperature of said heating system (4) and of said heating system (5) is between Tc−60° C. and Tc+20° C., preferably between Tc−20° C. and Tc+10° C., particularly a temperature equal to Tc, and the temperature of said heating system (6) is in any event less than the Tm, particularly a temperature equal to Tm−10° C.

In an eleventh variant of the invention, four heating systems are present, namely a heating system (2), particularly a laser heating system, a post-heating system (4), particularly an IR heating system, a preheating system (6), particularly an IR heating system, and a heating pressure roller heating system (3), and in particular the temperature of said heating system (4) is between Tc−60° C. and Tc+20° C., preferably between Tc−20° C. and Tc+10° C., particularly a temperature equal to Tc, and the temperature of said heating system (6) is in any event less than the Tm, particularly a temperature equal to Tm−10° C.

The Thermoplastic Polymer

The thermoplastic polymer can be reactive or non-reactive.

The expression “non-reactive thermoplastic polymer” means that the molecular weight is no longer likely to change significantly, that is, its number-average molecular weight (Mn) changes by less than 25% when it is processed and therefore corresponds to the final polyamide polymer of the thermoplastic matrix.

The expression “reactive thermoplastic prepolymer or reactive thermoplastic polymer” means that the molecular weight is likely to change significantly, that is, its number-average molecular weight (Mn) changes by more than 25% when it is processed and therefore does not correspond to the final polyamide polymer of the thermoplastic matrix.

The number-average molecular weight Mn of a non-reactive polymer is greater than 10,000 g/mol.

The number-average molecular weight Mn of a reactive prepolymer is between 5,000 g/mol and less than 10,000 g/mol.

The number-average molecular weight Mn of said final polymer of the thermoplastic matrix is preferably within a range extending from 10,000 g/mol to 40,000 g/mol, preferably from 12,000 g/mol to 30,000 g/mol. These Mn values can correspond to inherent viscosities greater than or equal to 0.8, as determined in m-cresol in accordance with ISO 307:2007, but changing the solvent (use of m-cresol in place of sulfuric acid and the temperature being 20° C.).

The Mn values are determined in particular by calculation on the basis of the content of the end functions, determined by potentiometric titration in solution.

The weights Mn can also be determined by size exclusion chromatography or by NMR.

Thermoplastic, thermoplastic prepolymer, or thermoplastic polymer is given to mean a material that is generally solid at ambient temperature, can be semicrystalline or amorphous, and which softens on an increase in temperature, in particular after passing its glass transition temperature (Tg), and flows at higher temperature when it is amorphous, or can exhibit obvious melting on passing its melting temperature (Tm) when it is semicrystalline, and which becomes solid again on a reduction in temperature below its crystallization temperature (for a semicrystalline polymer) and below its glass transition temperature (for an amorphous polymer).

The Tg and Tm are determined by differential scanning calorimetry (DSC) in accordance with standards 11357-2: 2013 and 11357-3: 2013 respectively.

The polymer can be an amorphous polymer with a glass transition temperature Tg greater than or equal to 80° C., in particular greater than or equal to 100° C., particularly greater than or equal to 120° C., in particular greater than or equal to 140° C., or is a semicrystalline polymer with a melting temperature Tm greater than 150° C.

Advantageously, said at least one thermoplastic polymer is selected from: poly(aryl ether ketone)s (PAEKs), in particular poly(ether ether ketone) (PEEK); poly(aryl ether ketone ketone)s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs), polyamides (PAs), in particular semiaromatic polyamides (polyphthalamides) optionally modified by urea moieties; PEBAs the Tm of which is greater than 150° C., polyacrylates, in particular polymethyl methacrylate (PMMA); polyolefins, in particular polypropylene, polylactic acid (PLA), polyvinyl alcohol (PVA), and fluoropolymers, in particular polyvinylidene fluoride (PVDF) or polytetrafluoroethylene (PTFE) or polychlorotrifluoroethylene (PCTFE); and mixtures thereof, in particular a mixture of PEKK and PEI, preferably 90-10% by weight to 60-40% by weight, in particular 90-10% by weight to 70-30% by weight.

Advantageously, said at least one thermoplastic polymer is selected from polyamides, aliphatic polyamides, cycloaliphatic polyamides and semiaromatic polyamides (polyphthalamides), PEKK, PEI and a mixture of PEKK and PEI.

The nomenclature used to define the polyamides is described in ISO 1874-1:2011 “Plastics—Polyamide (PA) moulding and extrusion materials—Part 1: Designation”, notably on page 3 (tables 1 and 2), and is well known to a person skilled in the art.

The polyamide can be a homopolyamide or a copolyamide or a mixture thereof.

For structural parts that must withstand high temperatures, besides the fluoropolymers, use is advantageously made according to the invention of PAEKs (polyaryl ether ketones) such as poly(ether ketone)s (PEKs), poly(ether ether ketone) (PEEK), poly(ether ketone ketone) (PEKK), poly(ether ketone ether ketone ketone) (PEKEKK) or PAs having a high glass transition temperature Tg.

Advantageously, said polyamide is chosen from aliphatic polyamides, cycloaliphatic polyamides and semiaromatic polyamides (polyphthalamides).

Advantageously, said aliphatic polyamide prepolymer is chosen from:
polyamide 6 (PA-6), polyamide 11 (PA-11), polyamide 12 (PA-12), polyamide 66 (PA-66), polyamide 46 (PA-46), polyamide 610 (PA-610), polyamide 612 (PA-612), polyamide 1010 (PA-1010), polyamide 1012 (PA-1012), polyamide 11/1010 and polyamide 12/1010, or a mixture thereof or a copolyamide thereof, and block copolymers, in particular polyamide/polyether (PEBA), and said semiaromatic polyamide is a semiaromatic polyamide optionally modified by urea moieties, in particular a PA MXD6 and a PA MXD10 or a semiaromatic polyamide of formula X/YAr, as described in EP1505099, in particular a semiaromatic polyamide of formula A/XT wherein A is selected from a moiety obtained from an amino acid, a moiety obtained from a lactam and a moiety corresponding to the formula (Ca diamine). (Cb diacid), with a representing the number of carbon atoms of the diamine and b representing the number of carbon atoms of the diacid, a and b each being between 4 and 36, advantageously between 9 and 18, the (Ca diamine) moiety being selected from linear or branched aliphatic diamines, cycloaliphatic diamines and alkylaromatic diamines and the (Cb diacid) moiety being selected from linear or branched aliphatic diacids, cycloaliphatic diacids, and aromatic diacids;
X.T denotes a moiety obtained from the polycondensation of a Cx diamine and terephthalic acid, with x representing the number of carbon atoms of the Cx diamine, x being between 6 and 36, advantageously between 9 and 18, in particular a polyamide of formula A/6T, A/9T, A/10T, or A/11T, A being as defined above, in particular a polyamide PA 6/6T, a PA 66/6T, a PA 61/6T, a PA MPMDT/6T, a PA PA11/10T, a PA 11/6T/10T, a PA MXDT/10T, a PA MPMDT/10T, a PA BACT/10T, a PA BACT/6T, or a PA BACT/10T/6T.

T corresponds to terephthalic acid, MXD corresponds to m-xylylenediamine, MPMD corresponds to methylpentamethylenediamine and BAC corresponds to bis(aminomethyl)cyclohexane.

Advantageously, said polymer is a semicrystalline polymer.

Advantageously, said semicrystalline polymer has a glass transition temperature such that Tg≥80° C., in particular Tg≥100° C., particularly 120° C., in particular ≥140° C., and a Tm≥150° C.

In this latter case, said at least one semicrystalline thermoplastic polymer is selected from: poly(aryl ether ketone)s (PAEKs), in particular poly(ether ether ketone) (PEEK); poly(aryl ether ketone ketone)s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs), polyamides (PAs), in particular semiaromatic polyamides (polyphthalamides) optionally modified by urea moieties; polyacrylates, in particular polymethyl methacrylate (PMMA); polyolefins, in particular polypropylene, polylactic acid (PLA), polyvinyl alcohol (PVA); and mixtures thereof, in particular a mixture of PEKK and PEI, preferably 90-10% by weight to 60-40% by weight, in particular 90-10% by weight to 70-30% by weight.

More advantageously, in this latter case, said at least one thermoplastic polymer is selected from polyamides, aliphatic polyamides, cycloaliphatic polyamides and semiaromatic polyamides (polyphthalamides), PEKK, PEI and a mixture of PEKK and PEI.

In one embodiment, said thermoplastic polymer additionally comprises carbon-based fillers, in particular carbon black, or carbon-based nanofillers, preferably selected from carbon-based nanofillers, in particular graphenes and/or carbon nanotubes and/or carbon nanofibrils, or mixtures thereof.

The Fibrous Material

Said fibrous material comprises continuous fibers selected from carbon fibers, glass fibers, silicon carbide fibers, basalt-based or basalt fibers, silica fibers, natural fibers in particular flax or hemp fibers, lignin fibers, bamboo fibers, sisal fibers, silk fibers, or cellulose fibers in particular viscose fibers, or amorphous thermoplastic fibers having a glass transition temperature Tg greater than the Tg of said polymer or of said mixture of polymers when the latter is amorphous or greater than the Tm of said polymer or of said mixture of polymers when the latter is semicrystalline, or semicrystalline thermoplastic fibers having a melting temperature Tm greater than the Tg of said polymer or of said mixture of polymers when the latter is amorphous or greater than the Tm of said polymer or of said mixture of polymers when the latter is semicrystalline, or a mixture of two or more of said fibers, preferably a mixture of carbon, glass or silicon carbide fibers, particularly carbon fibers.

The fibers that can form part of the composition of the fibrous materials can have different linear basis weights or sizes or numbering or “tex” and/or be in different numbers in the rovings. The most conventionally used rovings are thus composed of 600 to 4,800 tex for glass fibers and 3,000 (3K), 6,000 (6K), 12,000 (12K), 24,000 (24K), 48,000 (48K), 50,000 (50K), or 400,000 (400K) fibers for carbon fibers. Carbon fibers generally have a diameter close to 7-8 μm and glass fibers a diameter of approximately 13, 15, 17, or 20 μm, for example.

According to another aspect, the present invention relates to the use of the method as defined above for manufacturing three-dimensional composite parts, by automatic deposition of said ribbons using a robot.

Advantageously, said composite parts relate to the fields of transport, in particular motor vehicle transport, oil and gas, in particular offshore, hydrogen, gas storage, in particular hydrogen, aeronautical, nautical and railroad transport; renewable energy, in particular wind turbine or marine turbine, energy storage devices, solar panels; thermal protection panels; sports and leisure, health and medical, and electronics.

According to yet another aspect, the present invention relates to a three-dimensional composite part comprising n bands of fibrous material impregnated with a thermoplastic polymer deposited on a substrate as defined above.

In one embodiment, said composite part with a high degree of consolidation is characterized in that the average molecular weight of the amorphous or semicrystalline polymer is between 11,000 and 12,000 g/mol and the degree of crystallinity of said polymer is up to 25%.

Said composite part can then subsequently require solid-state polyconsolidation (SSP).

In another embodiment, said composite part with a high degree of consolidation is characterized in that the polymer is semicrystalline and has an average molecular weight of between 15,000 and 25,000 g/mol and the degree of crystallinity of said polymer is between 15 and 35%.

In yet another embodiment, said composite part with a high degree of consolidation is characterized in that the polymer is semicrystalline and has an average molecular weight of between 15,000 and 25,000 g/mol and in that the degree of porosity in the part before an optional post-consolidation step is less than 10%, preferably less than 5%, even more preferably less than 2%.

### DESCRIPTION OF THE FIGURES

FIG. 1 shows the different possible heating systems (2), (3), (4), and (6) on a fixed, flat substrate having an optional heating system (5).

FIG. 2 shows the different possible heating systems (4) and (6) combined on a rotating, cylindrical substrate optionally having a heating system (5).

FIG. 3 shows the different laser (2) and heating pressure roller (3) heating systems on a rotating, cylindrical substrate having a heating system (5) (heating mandrel).

FIG. 4 shows a composite part obtained according to example 2 of the invention.

FIG. 5 shows a composite part obtained according to comparative example 3.

FIG. 6 shows the micrograph of a band deposited with a consolidation roller.

FIG. 7 shows the micrograph of a band deposited without a consolidation roller.

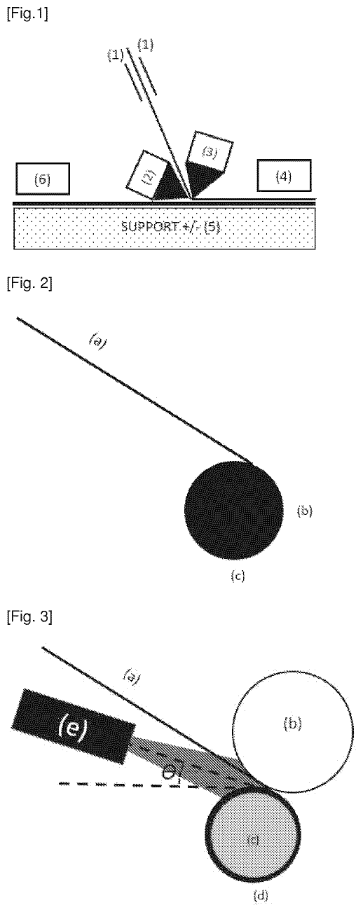

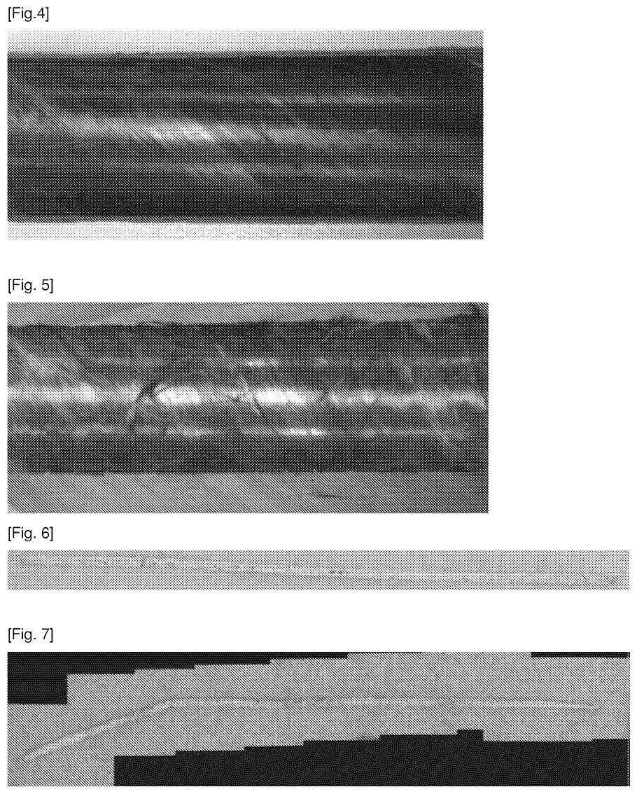

### EXAMPLES

### Example 1: Preparing Bands of Fibrous Material

The bands of fibrous material were prepared according to WO2018/234436: example 2 (monolayer band of fibrous material (Zoltex carbon fiber, 50K) impregnated with MPMDT/10T) and example 3 for the degree of porosity.

The content of fibers by volume of the impregnated band of fibrous material obtained is 53% vCF, its melting point is 258° C., its Tm_{endset} is 280° C., and its Tg is 125° C. The Tc of this polymer is 210° C.

### Example 2: Preparing Composite Parts by Deposition of Bands from Example 1 on a Heating Substrate (5) (Heating Mandrel) with a Heating System (3) that is a Heating Pressure Roller and a Heating System (2) that is a Laser Heating System as Described in FIG. 3

Overview of the Heating/Deposition Systems:

(3) is a heating pressure roller heating system. It consists of a metal cylinder mounted on rollers to allow it to rotate freely, all mounted on the robotic deposition head. It incorporates a heating system using heating cartridges integrated inside the metal roller and the temperature of which is controlled by thermocouples integrated into the heating cartridges. The power is transmitted to the cartridges wirelessly via a so-called brushless system, making it possible for the metal cylinder to rotate/revolve freely about its axis while being able to heat it without any risk of breaking the power connecting wires. The pressure exerted by the pressure roller on the band being deposited is exerted by the robotic head and measured using pressure sensors.

(5) is a metal mandrel on which the tapes are deposited in order to manufacture the tube by filament winding. Its heating system is identical to the system (3), with the difference that the heating cartridges are longer and there are more of them in order to heat the entire 4-m long mandrel uniformly. The mandrel is rotated by a brushless motor included in the system for mechanically supporting the mandrel, which makes it possible to rotate the mandrel on itself about its longitudinal axis of rotation at a set speed, which speed determines the speed of manufacturing the composite part. This speed is adjusted to match the speed of the deposition robot so that it deposits the tape at the appropriate speed.

(2) is a laser heating system. It is mounted on the head of the robot, the same head that holds the heating pressure roller and from which the tapes are guided during deposition. Its power is regulated via a temperature measurement taken by a thermal camera pointed at the band being deposited; the heating power increases if the band is too cold compared to the temperature setpoint requested by the operator. Conversely, it decreases if it is above this setpoint. The incident laser wave sent by the laser arrives in the zone to be heated (tape being deposited and interface between tape being deposited and tape already deposited) with a theta angle (θ); the laser can be oriented to change this angle and thus promote the heating at the interface or of one or other of the two surfaces to be placed in contact with each other.

Overview of the Temperature Measurement Systems:

The temperatures of the heating mandrel and the heating pressure roller are measured by the thermocouples integrated into these systems. The temperature of the tape being deposited and of the tape already deposited are indicated by thermal cameras. The temperature of the tape being deposited is measured in a zone situated just before contact with the pressure roller, i.e. at the moment of contact with the layer of tapes already deposited.

Overview of the Test Matrix:

The following parameters were kept constant throughout the duration of the composite tube manufacturing test matrix.
Mandrel diameter: 20.5 mm
Temperature of the heating mandrel for the first ply: 160° C.
Deposition speed of the first ply: 6 m/min
Pressure of the heating pressure roller for deposition of the first ply: 1 bar
Temperature of the heating pressure roller for deposition of the first ply: 320° C.
Deposition temperature of the first ply: 320° C.
Deposition speed of the 2nd and 3rd plies: 12 m/min
Pressure of the heating pressure roller for deposition of the 2nd and 3rd plies: 2 bar
Laser orientation (theta angle θ): 30°

The variable parameters are as follows:
Deposition temperature of the 2nd and 3rd plies: tests between 280 and 350° C.
Temperature of the heating mandrel for deposition of the 2nd and 3rd plies: tests between 100 and 310° C.
Temperature of the heating pressure roller for deposition of the 2nd and 3rd plies: tests between 260 and 300° C.
Temperature of the tapes already deposited at the time of deposition of the 2nd and 3rd plies: tests between 20 and 300° C.

Overview of the Results Obtained:
An improvement in consolidation is observed with a temperature of the tape already deposited of 220° C.; this is the case if the mandrel is heated to 250° C. during deposition at 12 m/min.
Consolidation and adhesion between plies is improved when a heating pressure roller at 300° C. is added in addition to the heating mandrel system.
The temperature of the tape already deposited that gives optimum results is 280° C., with the majority of the heating power being supplied by the laser, to which must be added the heat transmitted by the heating pressure roller (on the tape being deposited) and by the heating mandrel that heats the layer already deposited.

### Comparative Example 3: Preparing Composite Parts by Deposition of Bands from Example 1 without a Heating Pressure Roller

Overview of the Heating/Deposition Systems:

(5) is a metal mandrel on which the tapes are deposited in order to manufacture the tube by filament winding. It incorporates a heating system using heating cartridges integrated inside the metal cylinder and the temperature of which is controlled by thermocouples integrated into the heating cartridges. The power is transmitted to the cartridges wirelessly via a so-called brushless system, making it possible for the metal cylinder to rotate/revolve freely about its axis while being able to heat it without any risk of breaking the power connecting wires. The heating cartridges are of a sufficient size and sufficient in number to heat the entire 4-m long mandrel uniformly. The mandrel is rotated by a brushless motor included in the system for mechanically supporting the mandrel, which makes it possible to rotate the mandrel on itself about its longitudinal axis of rotation at a set speed, which speed determines the speed of manufacturing the composite part. This speed is adjusted to match the speed of the deposition robot so that it deposits the tape at the appropriate speed.

(2) is a laser heating system. It is mounted on the head of the robot, the same head that holds the heating pressure roller and from which the tapes are guided during deposition. Its power is regulated via a temperature measurement taken by a thermal camera pointed at the band being deposited; the heating power increases if the band is too cold compared to the temperature setpoint requested by the operator. Conversely, it decreases if it is above this setpoint. The incident laser wave sent by the laser arrives in the zone to be heated (tape being deposited and interface between tape being deposited and tape already deposited) with a theta angle (e); the laser can be oriented to change this angle and thus promote the heating at the interface or of one or other of the two surfaces to be placed in contact with each other.

Overview of the Temperature Measurement Systems:

The temperature of the heating mandrel is measured by the thermocouples integrated into this system. The temperature of the tape being deposited and of the tape already deposited are indicated by thermal cameras. The temperature of the tape being deposited is measured in a zone situated just before contact with the pressure roller, i.e. at the moment of contact with the layer of tapes already deposited.

Overview of the Test Matrix:

The following parameters were kept constant throughout the duration of the composite tube manufacturing test matrix.
Mandrel diameter: 20.5 mm
Temperature of the heating mandrel for the first ply: 160° C.
Deposition speed of the first ply: 6 m/min
Pressure of the heating pressure roller for deposition of the first ply: 1 bar
Temperature of the heating pressure roller for deposition of all of the plies: 20° C.
Deposition temperature of the first ply: 290° C.
Deposition speed of the 2nd and 3rd plies: 12 m/min
Pressure of the heating pressure roller for deposition of the 2nd and 3rd plies: 2 bar
Laser orientation (theta angle θ): 30°

The variable parameters are as follows:
Deposition temperature of the 2nd and 3rd plies: tests between 290 and 350° C.
Temperature of the heating mandrel for deposition of the 2nd and 3rd plies: tests between 150 and 230° C.
Temperature of the tapes already deposited at the time of deposition of the 2nd and 3rd plies: tests between 20 and 258° C.

Overview of the Results Obtained:
An improvement in consolidation is observed with a temperature of the tape already deposited of 220° C.; this is the case if the mandrel is heated to 250° C. during deposition at 12 m/min.
The temperature of the tape already deposited that gives optimum results is 300° C., with the majority of the heating power being supplied by the laser, to which must be added the heat transmitted by the heating pressure roller (on the tape being deposited) but from which the heat absorbed by the unheated pressure roller must be subtracted.
The adhesion results are generally less satisfactory than those obtained in the test matrix from example 2.

### Example 4: Comparing the Mechanical Properties of the Part from Example 2 and the Part from Example 3

The adhesion results are generally less satisfactory than those obtained in the test matrix from example 2.
This can be observed in terms of peel strength (three times lower) and consolidation of the plies (porosity twice as high).

### Example 5: Determining the Degree of Porosity—the Relative Deviation Between Theoretical Density and Experimental Density (General Method)

a) The data required are:
   The density of the thermoplastic matrix
   The density of the fibers
   The basis weight of the reinforcement:
   linear density (g/m) for example for a % inch tape (derived from a single roving)
   surface density (g/m²) for example for a wider tape or a woven fabric
b) Measurements to be performed:

The number of samples must be at least 30 so that the result is representative of the material studied.

The measurements to be performed are:
The size of the samples taken:
   Length (if linear density is known).
   Length and width (if surface density is known).
The experimental density of the samples taken:
   Measurements of mass in air and in water.
Measurement of the content of fibers is determined in accordance with ISO 1172:1999 or by thermogravimetric analysis (TGA) as determined for example in document B. Benzler, Applikationslabor, Mettler Toledo, Giesen, UserCom 1/2001.

The measurement of the content of carbon fibers can be determined in accordance with ISO 14127:2008.

Determining the theoretical weight content of fibers:
a) Determining the theoretical weight content of fibers:

$$\% {Mf}_{t h} = \frac{{m}_{l} \cdot L}{M {e}_{air}} \qquad [ Math 1 ]$$

where
mₗ is the linear density of the tape,
L is the length of the sample and
Meₐᵢᵣ is the mass of the sample measured in air.

The variation in the weight content of fibers is assumed to be directly linked to a variation in the content of matrix without taking into account the variation in the amount of fibers in the reinforcement.
b) Determining the theoretical density:

$${d}_{t h} = \frac{1}{\frac{1 - \% {Mf}_{th}}{{d}_{m}} + \frac{\% {Mf}_{t h}}{{d}_{f}}} \qquad [ Math . 2 ]$$

where dₘ and d_{f} are the respective densities of the matrix and of the fibers.

The theoretical density thus calculated is the accessible density if there is no porosity in the samples.
c) Evaluating the porosity:

The porosity is then the relative deviation between the theoretical density and the experimental density.

Key to FIGS. 2 and 3:

FIG. 2:
(a) Band being deposited
(b) Tube being manufactured on a rotating cylindrical substrate with heating system (5)
(c) (6) and (4) combined.

FIG. 3:
(a) Band being deposited
(b) Heating pressure roller
(c) Heating mandrel
(d) Tube being manufactured
(e) Laser

1. A method for preparing composite parts with a high degree of consolidation, comprising n bands of fibrous material impregnated with a thermoplastic polymer deposited on a substrate, characterized in that it comprises a step of depositing at least one band of fibrous material impregnated with a thermoplastic polymer on a substrate, by means of a main heating system selected from the following two systems:
a system for preheating said impregnated band of fibrous material before said band is deposited on said substrate, and
a system for heating said impregnated band of fibrous material on its inner face at the point of contact of said band with said substrate,
in combination with at least one secondary heating system selected from the following four:
a system for heating said impregnated band of fibrous material on its outer face at the point of contact of said band with said substrate,
a system for post-heating said impregnated band n of fibrous material after said band n is deposited on said substrate,
a system for heating said substrate, and
a system for preheating the impregnated band n−1 of fibrous material previously deposited before said band n of fibrous material is deposited,
or by means of the two main systems for heating said impregnated band of fibrous material before said band is deposited on said substrate and said impregnated band of fibrous material on its inner face at the point of contact of said band with said substrate, optionally combined with at least one of the four secondary systems: a system for heating said impregnated band of fibrous material on its outer face at the point of contact of said band with said substrate,
a system for post-heating said impregnated band n of fibrous material after said band n is deposited on said substrate,
a system for heating said substrate, and a system for preheating the impregnated band n−1 of fibrous material previously deposited before said band n of fibrous material is deposited,
said substrate being previously devoid of any deposited band or comprising at least one previously deposited band n−1 of said fibrous material impregnated with a thermoplastic polymer,
said at least two heating systems being present to increase the adhesion of said band to the substrate or to the previously deposited band n−1,
said thermoplastic polymer being an amorphous polymer, with a glass transition temperature such that Tg≥80° C., or a semicrystalline polymer with a melting temperature Tm≥150° C.,
the temperature of said band n to be deposited being constant throughout the deposition thereof on said substrate,
excluding the following heating pairs when only two heating systems are present:
a system for heating said impregnated band of fibrous material on its inner face at the point of contact of said band with said substrate and a system for heating said substrate, if said heating system is a laser heating system,
and excluding the following three systems when only three heating systems are present:
a system for preheating said impregnated band of fibrous material before said band is deposited on said substrate, a system for post-heating said impregnated band n of fibrous material after said band n has been deposited on said substrate, and a system for preheating the impregnated band n−1 of fibrous material previously deposited before said band n of fibrous material is deposited,
in the case of a cylindrical substrate simultaneously rotating about and translating along the axis of the cylinder, the three systems being infrared heating systems and the system for post-heating said impregnated band n of fibrous material after said band n has been deposited on said substrate and a system for preheating the impregnated band n−1 of fibrous material previously deposited before said band n of fibrous material is deposited being combined, and excluding the following three systems when only three heating systems are present:
a system for preheating said impregnated band of fibrous material before said band is deposited on said substrate, a system for heating said impregnated band of fibrous material on its inner face at the point of contact of said band with said substrate, and a system for heating said impregnated band of fibrous material on its outer face at the point of contact of said band with said substrate.

2. The method as claimed in claim 1, characterized in that said polymer is a semicrystalline polymer.

3. The method as claimed in claim 1, characterized in that at least one of the heating systems is selected from a system for preheating said impregnated band of fibrous material before said band is deposited on said substrate, a system for heating said impregnated band of fibrous material on its outer face at the point of contact of said band with said substrate, and a system for heating said impregnated band of fibrous material on its inner face at the point of contact of said band with said substrate.

4. The method as claimed in claim 3, characterized in that at least one other heating system is selected from a system for post-heating said impregnated band n of fibrous material after said band n has been deposited on said substrate, a system for heating said substrate, and a system for preheating the impregnated band n−1 of fibrous material previously deposited before said band n of fibrous material is deposited, and the temperature of said at least one other system for heating said substrate, and a system for preheating the impregnated band n−1 of fibrous material previously deposited before said band n of fibrous material is deposited, is between Tc−60° C. and Tc+20° C., Tc being the crystallization temperature as determined by differential scanning calorimetry in accordance with standard 11357-3:2013, and the temperature of said at least one other system for preheating the impregnated band n−1 of fibrous material previously deposited before said band n of fibrous material is deposited is less than Tm.

5. The method as claimed in claim 4, characterized in that the degree of crystallinity of the thermoplastic polymer in the band after it has been deposited is greater than 5%.

6. The method as claimed in claim 3, characterized in that the temperature of the band n at the time of deposition at the point of contact of the band n with the band n−1 is constant.

7. The method as claimed in claim 1, characterized in that said at least one heating system is selected from a heat transfer fluid, induction heating, direct current, a heating cartridge, a heating pressure roller, a light-emitting diode, infrared, a source of UV, hot air, or a laser.

8. The method as claimed in claim 7, characterized in that said heating systems present are all infrared systems with the exception of the system for heating said substrate, which can also be selected from a heat transfer fluid, direct current, a heating cartridge, and induction heating.

9. The method as claimed in claim 1, characterized in that two heating systems are present, one being a system for preheating said impregnated band of fibrous material before said band is deposited on said substrate, and the other being a system for post-heating said impregnated band n of fibrous material after said band n has been deposited on said substrate or a system for preheating the impregnated band n−1 of fibrous material previously deposited before said band n of fibrous material is deposited, an infrared heating system being excluded from at least one of the system for preheating said impregnated band of fibrous material before said band is deposited on said substrate and a system for post-heating said impregnated band n of fibrous material after said band n has been deposited on said substrate or a system for preheating said impregnated band of fibrous material before said band is deposited on said substrate and a system for preheating the impregnated band n−1 of fibrous material previously deposited before said band n of fibrous material is deposited when they are both present.

10. The method as claimed in claim 9, characterized in that a system for heating said impregnated band of fibrous material on its outer face at the point of contact of said band with said substrate is additionally present, said system for heating said impregnated band of fibrous material on its outer face at the point of contact of said band with said substrate being a heating pressure roller.

11. The method as claimed in claim 1, characterized in that two heating systems are present, one being a system for heating said impregnated band of fibrous material on its inner face at the point of contact of said band with said substrate and the other a system for heating said substrate, a laser heating system being excluded from said system for heating said impregnated band of fibrous material on its inner face at the point of contact of said band with said substrate and the temperature of said at least one other system for heating said substrate is between Tc−60° C. and Tc+20° C., Tc being the crystallization temperature as determined by differential scanning calorimetry in accordance with standard 11357-3:2013.

12. The method as claimed in claim 1, characterized in that two heating systems are present, one being a system for heating said impregnated band of fibrous material on its inner face at the point of contact of said band with said substrate, and the other being a system for post-heating said impregnated band n of fibrous material after said band n has been deposited on said substrate or a system for preheating the impregnated band n−1 of fibrous material previously deposited before said band n of fibrous material is deposited, said system for heating said impregnated band of fibrous material on its inner face at the point of contact of said band with said substrate being a laser heating system and said system for post-heating said impregnated band n of fibrous material after said band n has been deposited on said substrate or system for preheating the impregnated band n−1 of fibrous material previously deposited before said band n of fibrous material is deposited being an infrared heating system.

13. The method as claimed in claim 12, characterized in that a system for heating said substrate is additionally present.

14. The method as claimed in claim 1, characterized in that said at least one thermoplastic polymer is selected from: poly(aryl ether ketone)s (PAEKs); poly(aryl ether ketone ketone)s (PAEKKs); polyaryl sulfones; polyaryl sulfides, polyamides (PAs); PEBAs the Tm of which is greater than 150° C., polyacrylates; polyolefins, polylactic acid (PLA), polyvinyl alcohol (PVA), and fluoropolymers; and mixtures thereof.

15. The method as claimed in claim 1, characterized in that said at least one thermoplastic polymer is selected from polyamides, aliphatic polyamides, cycloaliphatic polyamides and semiaromatic polyamides (polyphthalamides), PEKK, PEI and a mixture of PEKK and PEI.

16. The use of the method as defined in claim 1, for manufacturing three-dimensional composite parts, by automatic deposition of said ribbons using a robot.

17. The use as claimed in claim 16, characterized in that said composite parts relate to the fields of transport; renewable energy; thermal protection panels; sports and leisure, health and medical, and electronics.

18. A three-dimensional composite part, comprising n bands of fibrous material impregnated with a thermoplastic polymer deposited on a substrate as defined in claim 1.

19. A composite part with a high degree of consolidation as claimed in claim 18, characterized in that the average molecular weight of the amorphous or semicrystalline polymer is between 11,000 and 12,000 g/mol and the degree of crystallinity of said polymer is up to 25%.

20. A composite part with a high degree of consolidation as claimed in claim 18, characterized in that the polymer is semicrystalline and has an average molecular weight of between 15,000 and 25,000 g/mol and the degree of crystallinity of said polymer is between 15 and 35%.

21. A composite part with a high degree of consolidation as claimed in claim 18, characterized in that the polymer is semicrystalline and has an average molecular weight of between 15,000 and 25,000 g/mol and in that the degree of porosity in the part before an optional post-consolidation step is less than 10%.
